(19) United States
(12) Patent Application Publication
(10) Pub. No.: US 2026/0289072 A1
(43) Pub. Date: Sep. 24, 2026

(54) SERVER AND USER TERMINAL OF THE THESIS MAKING SYSTEM THAT PROVIDES INFORMATION ON THE EXTRACTED ORIGINAL TEXT

(71) Applicant: Taehyeon KWON, Cheonan-si, Chungcheongnam-do (KR)

(72) Inventor: Taehyeon KWON, Cheonan-si, Chungcheongnam-do (KR)

(21) Appl. No.: 18/708,822

(22) PCT Filed: Nov. 15, 2022
(86) PCT No.: PCT/KR2022/017978

§ 371 Date: Jun. 4, 2026

(30) Foreign Application Priority Data
Nov. 7, 2022 (KR) 10-2022-0147115

(51) Int. Cl. G06F 40/166; G06F 40/106; H04L 9/08

(52) U.S. Cl. CPC G06F 40/166; G06F 40/106; H04L 9/0866

(57) ABSTRACT

The present disclosure may include a communication unit communicably connected between a terminal that receives authoring data for making a thesis, and a database including references for making the thesis, a scanning unit that scans a reference retrieved from the database, recognizes characters and images corresponding to the scanned reference to generate extract data, and extracts unique information of the reference, a blocking unit that blocks characters and images inserted into the thesis based on the authoring data or the extract data into blocks, and generates block information including identification information of the blocks, and a controller that controls, when a block in the thesis is an extract block generated by the extract data, the blocking unit to generate block information further including unique information of the reference, and to match the block information further including the unique information of the reference to the extract block.

### CROSS-REFERENCE TO RELATED APPLICATIONS

This application is the National Stage filing under 35 U.S.C. 371 of International Application No. PCT/KR2022/017978, filed on Nov. 15, 2022, which claims the benefit of earlier filing date and right of priority to Korean Application No. 10-2022-0147115, filed on Nov. 7, 2022, the contents of which are all hereby incorporated by reference herein in their entirety.

### TECHNICAL FIELD

The present disclosure relates to a system for making a thesis, and more particularly, to a thesis making system that automatically provides, when there is content extracted from a reference in the thesis, information on the reference.

### BACKGROUND ART

In general, a thesis, which is a document that systematically describes a result of academic research, may typically be a document intended to present more advanced research results in relation to existing research results, existing problems or present situations, and the like. Such a thesis may be used as a measure of a thesis author's research achievements or degree.

Meanwhile, as mentioned above, in the case of the thesis, there are many cases where relevant content is extracted from existing published documents to be included in the thesis in order to mention existing problems, present situations, or existing research results and explain advanced research results in relation thereto. However, while extracting and describing content from existing research results or references in this manner, to present as if they were the thesis author's research results or to exaggerate one's own research results, there is a problem in that many plagiarized theses are submitted without mentioning that the content included therein is extracted content.

Therefore, in order to filter out such plagiarized theses, there is a review process for reviewing theses, and the plagiarized theses or the inventiveness of research results may be determined through the review process, and selected as suitable theses according to the determined results.

Meanwhile, for the purpose of reviewing the theses, it is necessary to substantially differentiate between content extracted from references in a written thesis and content written directly by the thesis author. To this end, it is necessary to retrieve references that match the content of theses suspected of simple extracts (plagiarism), but in practice, if the thesis author does not disclose reference information, then numerous theses must be checked one by one to find the original text. However, as more than hundreds of thousands of theses are currently published worldwide every year, there is a problem in that it is difficult for a reviewer to check each of the theses to determine whether there is plagiarism.

Accordingly, at present, methods have emerged to detect whether there is plagiarism by comparing the content of numerous theses stored in a preset thesis database using artificial intelligence or weighting based on sentence semantic analysis for portions of theses suspected of plagiarism. However, these methods have a problem in that the more theses to compare, the longer the calculation time takes. Furthermore, in order to solve the problem of the calculation time, a method has emerged to retrieve theses to be included in a control group from the thesis database mainly with keywords or thesis fields and to detect whether there is plagiarism in the retrieved theses, but this method has a problem in that it is vulnerable to plagiarism from theses that are not retrieved through the retrieval of keywords or fields. Accordingly, when extracts from references are included in a thesis while making the thesis, there is a need for a thesis making system that allows information from the references, that is, the original text, to be automatically included in the thesis.

Meanwhile, when the thesis author partially modifies the content of the original text and describes his or her opinion, there is a problem in that it is difficult to differentiate between a portion extracted from the references and a portion written by the thesis author through mechanical determination based on artificial intelligence or mechanical semantic analysis. Therefore, in order to clearly determine whether a portion of the thesis including the extract is simple plagiarism or a portion including the thesis author's research results, from among the portion of the thesis including the extract, it must be clearly determined to differentiate between a portion extracted from the original text and a portion written by the thesis author.

However, at present, there is a problem in that the reviewer must determine according to a portion revealed by the thesis author himself or herself or retrieve a portion that completely matches the references, that is, the original text, by a program for detecting the plagiarism, or the like, and directly differentiate between an extracted portion and a portion written by the thesis author based on the retrieved results and a portion of the thesis including the extract. As a result, there is a need for a thesis making system capable of automatically distinguishing, when a portion extracted from the references is included while making a thesis, and the thesis author makes a modification such as a change or addition of content to the extracted portion, between the extracted portion and the portion modified by the thesis author.

### DISCLOSURE OF INVENTION

### Technical Problem

The present disclosure aims to solve the foregoing and other problems, and an aspect of the present disclosure is to provide a server for a thesis making system that collects, when references requested by a thesis author are provided, and the author extracts a portion of the content of references while making a thesis and inserts the extracted portion into the thesis, information related to the references together with the written thesis, and a terminal that allows the thesis to be written through the thesis making system.

In addition, an aspect of the present disclosure is to provide a server of a thesis making system that allows an author to easily differentiate between a portion extracted from references and a portion written by the author from a written thesis, and a terminal that allows the thesis to be written through the thesis making system.

### Solution to Problem

In order to achieve the foregoing and other objectives, according to an aspect of the present disclosure, a service server of a thesis making system according to an embodiment of the present disclosure may include a communication unit communicably connected between a preset terminal that receives authoring data including characters and images for making a thesis, and a database including references for making the thesis; a scanning unit that scans a portion of a reference retrieved from the database, recognizes characters and images corresponding to the scanned portion of the reference to generate extract data, and extracts unique information of the reference corresponding to the portion of the reference; a blocking unit that blocks characters and images inserted into the thesis based on the authoring data or the extract data into blocks according to a preset unit, and generates block information matching respective blocks, and including identification information of the matching blocks; and a controller that performs a retrieval for the reference according to a retrieval request received from the terminal, inserts characters and images according to the authoring data or the extract data to make the thesis, and controls, when a block consisting of characters or images inserted into the thesis is an extract block generated by the extract data, the blocking unit to generate block information further including unique information of the reference, and to match the block information further including the unique information of the reference to the extract block.

According to an embodiment, the preset unit may be any one of a sentence, a paragraph, a page, and a chapter.

According to an embodiment, the controller may match, when the block consisting of characters or images inserted into the thesis is a genesis block that does not include the characters and images recognized from the reference, block information that does not include the unique information of the reference to the genesis block, wherein the thesis consists of at least one of the genesis blocks and at least one of the extract blocks.

According to an embodiment, the unique information of the reference may be position information including a position corresponding to a portion of the reference, wherein the controller provides a link to the retrieved reference through the unique information of the reference.

According to an embodiment, the unique information of the reference may further include, when a portion of the reference is extracted from another reference, the unique information of the other reference, wherein the controller further provides a link to the retrieved reference and a link according to the unique information of the other reference.

According to an embodiment, the controller may provide, according to a request from the terminal, history information that tracks a history of extracting a portion of the reference from a document of a first author who first wrote the portion of the reference to its insertion into the thesis.

According to an embodiment, the controller may control, when at least one character or image constituting the extract block is changed or at least one character or image is added into the extract block, the blocking block to divide the extract block into different extract blocks that match block information including unique information of the same reference, around the at least one changed or added character or image, and to block the changed or added character or image into a genesis block matching block information that does not include the unique information of the reference.

According to an embodiment, the controller may control the blocking unit to differentiate, when the extract block consists of an image and editing is performed on the image, between an unedited portion and an edited portion of the image through tracking the editing process, and to match the unedited and edited portions of the image to the block information of the extract block that further includes unique information of the reference, and the block information of the genesis block that does not include the unique information of the reference, respectively.

According to an embodiment, the controller may encrypt, according to a request from the terminal, the thesis being written with an encryption key based on a combination of terminal identification information of the terminal, user identification information of the terminal user, and last modified time information of the thesis to transmit the encrypted thesis to the terminal.

According to an embodiment, the service server may further include an imaging unit that scans each page of the thesis being written to generate image data corresponding to the each page; and a conversion unit that encodes the image data into character string data, wherein the controller inserts, when the image data is encoded into the string data, any one of the user identification information, the terminal identification information, and the last modified time information of the thesis as a drawing key into a preset position of the character string data, and encrypts the character string data into which the drawing key is inserted with the encryption key.

According to an embodiment, the controller may arbitrarily select any one of the user identification information, the terminal identification information, and the last modified time information of the thesis to insert the selected information into the drawing key, wherein the user identification information, the terminal identification information, and the last modified time information of the thesis are formed of the same number of characters.

In order to achieve the foregoing and other objectives, according to an aspect of the present disclosure, a terminal that receives preview data of an encrypted thesis from a service server that provides a function of making the thesis may include a display unit; a communication unit that receives preview data of the encrypted thesis from the service server; a decryption unit that decrypts the preview data of the encrypted thesis into character string data; a decoding unit that decodes the character string data into binary data of image data corresponding to the preview data of the thesis; a drawing unit that draws an image corresponding to the decoded binary data in a preset region on the display unit; and a controller that generates a decryption key using a combination of user identification information previously stored in the terminal, terminal identification information of the terminal, and last modified time information of the thesis, and controls the decryption unit to decrypt the preview data of the encrypted thesis using the generated decryption key.

According to an embodiment, the last modified time of the thesis may be provided from the service server, and updated each time the author terminal making the thesis makes a request for storing the thesis being written through the service server.

According to an embodiment, the controller may extract, when the encrypted thesis preview data is decrypted into character string data, a preset number of characters from a preset position among the characters of the decrypted character string data as a drawing key, and remove the extracted characters from the character string data when the extracted drawing key matches a drawing key previously stored in the terminal.

According to an embodiment, the drawing key may be any one of the user identification information, the terminal identification information, and the last modified time of the thesis, wherein the user identification information, the terminal identification information, and the last modified time of the thesis are formed of the same number of characters.

### Advantageous Effects of Invention

The effects of a server and a user terminal in a thesis making system according to the present disclosure will be described as follows.

According to at least one of the embodiments of the present disclosure, the present disclosure allows, when references requested by a thesis author are provided, and a user extracts a portion of the provided references and inserts it into the thesis, information that can track the reference from which the portion is extracted to be automatically stored. Therefore, there is an advantage in that it is easy to identify an extracted portion in the thesis, and it is easy to retrieve a reference from which the portion is extracted. Furthermore, the extracted information of the reference is automatically stored, and thus there is an advantage in that the author does not need to separately store the information of the reference.

In addition, according to at least one of the embodiments of the present disclosure, when the author modifies a part of the extracted portion and inserts it into the thesis, there is an effect capable of easily comparing the original text of the reference corresponding to the extracted portion with the content of a portion changed by the author's modification based on tracking information of the extracted portion.

In addition, according to at least one of the embodiments of the present disclosure, it has a configuration of imaging a thesis written until the present, encoding the imaged thesis into a character string, and inserting a preset drawing key into the encoded data, and has a configuration of extracting, by a device designated as a viewer, a drawing key from a predefined drawing key insertion position and decoding an imaged thesis from the encoded data from which the drawing key is removed. Therefore, when the drawing key is not removed or incorrect data is removed, the encoded data may not be decoded into correct image data, thereby having an effect capable of preventing the thesis being written from being displayed by a non-suitable user or on an unsuitable terminal.

### BRIEF DESCRIPTION OF DRAWINGS

FIG. 1 is a block diagram for explaining a thesis making system according to an embodiment of the present disclosure.

FIG. 2 is a block diagram for explaining a service server of the thesis making system according to an embodiment of the present disclosure.

FIG. 3 is a flowchart showing an operation process of writing a thesis in the service server of the thesis making system according to an embodiment of the present disclosure.

FIG. 4 is an exemplary diagram showing an example of blocking a partial character string extracted from a reference while making a thesis in the thesis making system according to an embodiment of the present disclosure into an extract block including a unique hash value of the reference.

FIG. 5 is a flowchart showing an operation process of dividing, when there is a modification to an extracted portion, the modified portion into a genesis block in the thesis making system according to an embodiment of the present disclosure.

FIG. 6 is an exemplary diagram showing an example in which an extract block is divided into a genesis block including the modified portion and an extract block according to the operation process of FIG. 5.

FIG. 7 is an exemplary diagram showing an example in which block information on each of an edited portion and an original image is generated according to the operation process of FIG. 5 when the extracted portion is an image.

FIG. 8 is a flowchart showing an operation process of generating a table of contents structure model that displays information on block information generated according to an embodiment of the present disclosure.

FIG. 9 is a block diagram for explaining the service server of the thesis making system according to an embodiment of the present disclosure that provides an encrypted preview function for a thesis being written.

FIG. 10 is a block diagram for explaining a viewer terminal in the thesis making system that provides an encrypted preview function of the thesis.

FIG. 11 is a flowchart showing an operation process between a service server and a user terminal that provide an encrypted preview service of the thesis in the thesis making system according to the embodiment of the present disclosure.

FIG. 12 is a flowchart showing an operation process of encrypting, by a service server that provides an encrypted thesis preview service, encoded data in which a drawing key is inserted according to an embodiment of the present disclosure.

FIG. 13 is a flowchart showing an operation process of decoding, by a viewer terminal according to an embodiment of the present disclosure, encoded data in which a drawing key is inserted, received from a service server that provides an encrypted thesis preview service according to an embodiment of the present disclosure.

### MODE FOR THE INVENTION

It should be noted that technical terms used herein are merely used to describe specific embodiments, and are not intended to limit the present disclosure. Furthermore, a singular expression used herein includes a plural expression unless it is clearly construed in a different way in the context. A suffix “module” or “unit” used for elements disclosed in the following description is merely intended for easy description of the specification, and the suffix itself is not intended to have any special meaning or function.

As used herein, terms such as “comprise” or “include” should not be construed to necessarily include all elements or steps described herein, and should be construed not to include some elements or some steps thereof, or should be construed to further include additional elements or steps.

In addition, in describing technologies disclosed herein, when it is determined that a detailed description of known technologies related thereto may unnecessarily obscure the subject matter disclosed herein, the detailed description will be omitted.

Furthermore, the accompanying drawings are provided only for a better understanding of the embodiments disclosed herein and are not intended to limit technical concepts disclosed herein, and therefore, it should be understood that the accompanying drawings include all modifications, equivalents and substitutes within the concept and technical scope of the present disclosure. In addition, not only individual embodiments described below but also a combination of the embodiments may, of course, fall within the concept and technical scope of the present disclosure, as modifications, equivalents or substitutes included in the concept and technical scope of the present disclosure.

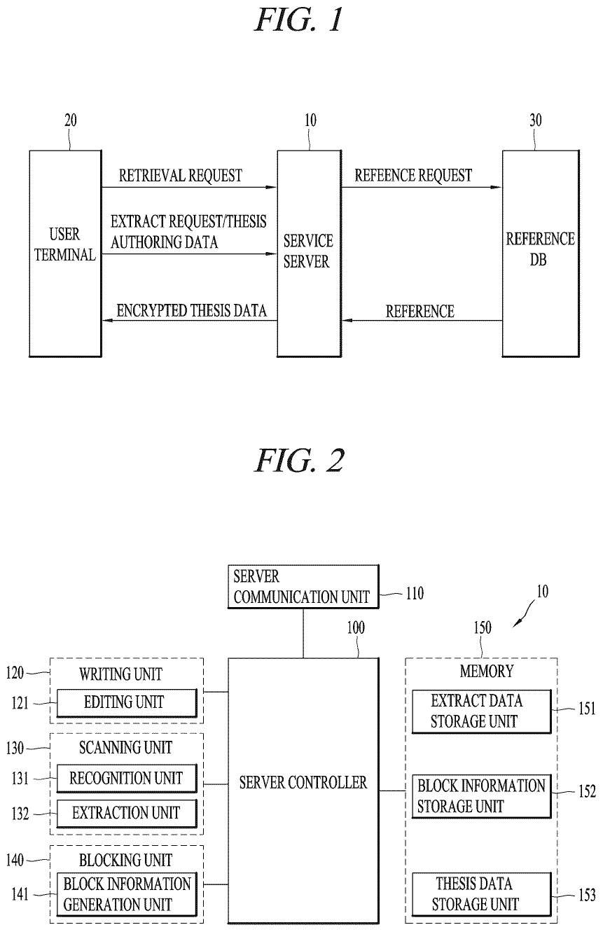

FIG. 1 is a block diagram for explaining a thesis making system according to an embodiment of the present disclosure.

Referring to FIG. 1, a thesis making system according to an embodiment of the present disclosure may include a reference database (DB) 30 that includes a plurality of references that can be requested for making a thesis and is configured to provide the references upon request, a service server 10 that retrieves a reference from the reference database 30 according to a request a user terminal 20, provides a view of the retrieved reference so that the user terminal 20 can view the retrieved reference, and provides a thesis making service so that a thesis including a character string and an image received from the user terminal 20 can be written, and the user terminal 20 that accesses the service server 10 to make a request for retrieving a reference to make a thesis, view the retrieved reference, and transmit an extract request for a character string, an image, or a portion of the retrieved reference for making a thesis to the service server 10.

First, the reference database 30 may provide an electronic reference, that is, reference data, in response to an interaction with the service server 10. Here, the interaction with the service server 10 may be a response to receiving a retrieval request for a specific reference.

As an example, the reference database 30, which may be a database including theses accepted by at least one academic organization, may provide a reference according to a request from the service server 10 based on a supply contract concluded between an operating entity of the service server 10 and an operating entity of the reference database 30. In this case, the operating entity of the reference database 30 may receive compensation corresponding to references provided based on the supply contract. Accordingly, when a fee is required to retrieve the requested reference, the service server 10 may transmit information related to the required fee to the user terminal 20, and perform a retrieval of the reference when payment for the required fee is completed.

In addition, the service server 10 may provide a thesis making service for making a thesis according to a request from the user terminal 20. In this case, the service server 10 may provide a thesis making service only to a user authenticated through an authentication process.

The thesis making service may be a service for making a thesis including thesis authoring data received from the user terminal 20. Additionally, a user may input images and characters to be inserted into a thesis through the thesis making service, and the service server 10 may allow the images and text received through the user terminal 20 to be included in the thesis the user is currently writing to make a thesis. Furthermore, the images and input characters included in the thesis being written may be stored in the service server 10 as thesis data for the thesis being written by the user.

Here, the thesis being written may be blocked into different blocks according to a preset unit. As an example, the thesis may be divided into different blocks for each sentence, paragraph, page, or chapter. As an example, respective paragraphs that constitute the thesis being written may be blocked into different blocks.

The blocks may include unique block information, respectively. Here, the block information may include a serial number of each block, a time at which the block was generated or modified, and a hash value (hereinafter referred to as unique hash value), which is a unique value. Here, the unique hash value may be an invariant value consisting of alphabet characters and numerals according to a preset number of digits as an identification value for identifying the corresponding block.

In addition, the service server 10 may perform a retrieval of a reference from the reference database 30 according to a request received from the user terminal 20. Furthermore, the user terminal 20 may be allowed to view the retrieved reference according to a reference retrieval request. Additionally, a function of marking a portion of the reference allowed to be viewed according to the user's request may be provided, and an extract function that allows the user to extract the marked portion may be provided.

When the extract function is requested, the service server 10 may receive a request for extracting the marked portion from the user. Then, the service server 10 may scan a portion of the marked reference in response to the received extract request and recognize a character string or image included in the scanned portion. In this way, a character string or image scanned, recognized, and extracted from the marked portion of the reference will be referred to as a piece. Furthermore, the piece may be stored in the service server 10 as extract data extracted from the reference.

Then, the service server 10 may block and store the recognized character string or image, that is, the piece, as one block including unique block information. Here, the block information may include a serial number of each block, a time at which the block was generated or modified, and a unique hash value. In addition, when the piece consists only of a character string or image, the recognized character string or image may generate each block. Meanwhile, when the piece includes a character string and at least one image included between the character strings, one block including the character string and the at least one image may be generated.

However, as described above, the piece may be a scanned and recognized portion of a reference. Accordingly, a block generated from the piece may correspond to the scanned portion of the reference. Accordingly, the service server 10 may block the piece into a block having block information that further includes unique information of the reference. Hereinafter, a block generated from the piece, which has block information that further includes unique information of the reference will be referred to as an extract block.

Here, the unique information of the reference included as block information of the extract block may be unique information indicating the entire reference when the reference is not blocked by a preset unit, for example, a page, sentence, paragraph, or chapter. However, when the reference is blocked into different blocks for each sentence, paragraph, page, or chapter, at least one unique information corresponding to at least one block of the reference may be included as block information of the extract block.

Meanwhile, the unique information of the reference, which is identification information capable of identifying the reference, may be a unique hash value corresponding to the reference, that is, a unique hash value. In addition, at least one unique information corresponding to at least one block of the reference may be at least one unique hash value corresponding to at least one block of the reference. That is, an extract block generated from a piece scanned and recognized from a portion of a reference may further include a unique hash value capable of identifying the portion of the reference as block information. In this case, a character string or image scanned and recognized from a different paragraph of the reference may constitute a different piece, and the service server 10 may generate, for each piece, a different extract block including unique hash values of different paragraphs of the reference as hash pointers.

Meanwhile, the service server 10 may insert the extract data into the thesis currently being written by the user according to a request received from the user terminal 20. In this case, the service server 10 may block extract data, that is, a piece included in the thesis. Therefore, the piece, which is a block included in thesis data, may be blocked into a block with a unique hash value. In this case, the block information of a block of thesis data generated from the piece, a unique hash value corresponding to the reference corresponding to a piece as described above, that is, a portion of the original text, may be blocked as a block that further includes another hash value, that is, a hash pointer value, differentiated from the unique hash value as a block included in the thesis data, in addition to the unique hash value as a block included in the thesis data. That is, it may be blocked as an extract block.

On the contrary, the service server 10 may receive a character string or image directly written by the user to insert the received character string or image into the thesis currently being written. In this case, the character string or image directly written by the user is not an extract and thus there may be no reference. Therefore, the block of the thesis into which a character string or image directly written by the user is inserted may be blocked as a block with only a unique hash value as a block included in the thesis data. Hereinafter, a block with only a unique hash value as a block included in the thesis data as described above will be referred to as a genesis block.

Therefore, a thesis written through the service server 10 according to an embodiment of the present disclosure may include at least one genesis block and at least one extract block.

Additionally, the service server 10 may provide a preview service for the thesis currently being written according to a request from the user terminal 20. In this case, the preview service may be a service that allows the user to view the thesis being written on a device designated in advance. In addition, the thesis data displayed through the preview service, which is provided in the form of an image, may be a service that displays the content of the thesis being written in a restricted editing state. Additionally, the thesis data provided to the user terminal 20 for the preview service may be data encrypted through a preset encryption key.

Meanwhile, the user terminal 20, which is a terminal of a thesis author who wants to make a thesis, may be a terminal configured to enable wireless connection with the service server 10. As an example, for the user terminal 20, various types of terminals including an input unit capable of inputting a character or image, such as a mobile phone, a smart phone, a laptop computer, a slate PC, a tablet PC, an ultrabook, a desktop computer, and the like may be used as the user terminal.

Meanwhile, FIG. 2 is a block diagram for explaining the service server 10 of a thesis making system according to an embodiment of the present disclosure.

Referring to FIG. 2, the service server 10 constituting the thesis making system according to an embodiment of the present disclosure may include a server controller 100, and a server communication unit 110, a writing unit 120, a scanning unit 130, a blocking unit 140, and a memory 150, which are connected to the server controller 100, and controlled by the server controller 100. The elements shown in FIG. 2 are not essential for implementing the service server 10, and thus the service server 10 described herein may have more or fewer element than those listed above.

First, the server communication unit 110 may be connected to the reference database 30 and the user terminal 20 through a wired or wireless communication network. The server communication unit 110 may receive thesis authoring data, that is, a character string and an image, received for making a thesis from the user terminal 20, and may receive a retrieval request for a specific reference. Furthermore, the server communication unit 110 may be connected to the reference database 30 to perform a retrieval of a reference corresponding to the retrieval request, and may receive data of the retrieved reference (hereinafter referred to as reference data).

Here, the reference data may be blocked data according to a preset unit such as a page, sentences, paragraphs, or chapter, as described above. In this case, when the preset unit is a paragraph, the reference data may be data including a plurality of blocks that are blocked with block information having different block information for each paragraph. In this case, the block information may include a serial number of each block, a time stamp indicating the time at which each block was generated and modified, and a unique hash value.

Furthermore, the server communication unit 110 may allow, in response to the reference retrieval request under the control of the server controller 100, the user terminal 20 to access a region of the memory 150 in which the received reference data is stored. Accordingly, the user may be allowed to view the retrieved reference.

In addition, the server communication unit 110 may be communicably connected to a pre-designated device (designated device) that is allowed to preview thesis data being written. Furthermore, according to a request received from the designated device, encrypted thesis data may be transmitted to the designated device. Here, the designated device may be the same device as the user terminal 20 that is used by the user to make the thesis, or may be another device set in advance by the user.

Furthermore, the writing unit 120 may make a thesis based on thesis authoring data received from the user. Here, the user may be an authenticated user. That is, the user may request a thesis making function from the service server 10 through user authentication, and a thesis being written by the authenticated user may be allowed for editing only by the authenticated user through the authentication process.

The authenticated user may input thesis authoring data such as characters or images to be inserted into the thesis being written by himself or herself into the service server 10, and the writing unit 120 may provide an editing function for the authoring data to insert the input thesis authoring data into a position on the thesis desired by the user. Meanwhile, the writing unit 120 may include an editing unit 121 capable of editing images to allow the user to edit images through the user terminal 20 and insert them into the thesis being written.

Meanwhile, the scanning unit 130 may scan, for a reference allowed to be viewed according to a request from the user terminal 20, a portion of the reference marked by the user. Furthermore, the scanned portion of the reference may be recognized as a character string or image. In this case, the scanning unit 130 may recognize characters from the scanned portion of the reference, through a technology such as optical character recognition (OCR), and may recognize, in the case of an image that is difficult to recognize as a character, the image as an image itself. Furthermore, the recognized characters and images may be stored in the memory 150 as data (extract data) extracted from the reference. To this end, the scanning unit 130 may include a recognition unit 131 for recognizing a character string and an image from scanned data.

Here, the recognition unit 131 may recognize characters and images according to a paragraph structure of the scanned portion of the reference. Therefore, characters and images having the same paragraph structure as that of the scanned reference may be recognized, and the recognized characters and images may be stored as extract data.

In addition, the scanning unit 130 may extract a unique hash value of the reference from the reference data. To this end, the scanning unit 130 may further include an extraction unit 132 for extracting at least one unique hash value corresponding to the scanned and recognized portion of the reference. Here, when the reference is blocked for each page, sentence, paragraph, or chapter, the extraction unit 132 may extract at least one unique hash value according to the scanned and recognized page, sentence, paragraph, or chapter of the reference. Furthermore, at least one extracted unique hash value may be stored in the memory 150 as extract data.

Meanwhile, the blocking unit 140 may perform blocking on characters and images received from the user terminal 20 and inserted into the thesis being written by a preset unit such as a page, sentence, paragraph, or chapter. As an example, when the preset unit is ‘paragraph’, the blocking unit 140 may perform blocking on each paragraph generated by character strings and images inserted into the thesis being written. In this case, the characters or images constituting one paragraph may form one block.

Meanwhile, the blocking unit 140 may generate block information corresponding to the formed block. The block information may include a unique hash value, which is unique information of the block, a block serial number according to the paragraph order of a thesis being written, and information on a time at which the block was generated or modified, that is, time stamp information. Here, the unique hash value may consist of alphabet characters and numerals according to a preset number of digits, and may be an invariant value. In order to generate such block information, the blocking unit 140 may include a block information generation unit 141.

However, the character string or image input for making the thesis may be a scanned and recognized portion of a reference. Furthermore, as described above, the reference may have a unique hash value corresponding to the page, sentence, paragraph, or chapter.

In this case, when a character string or image having a unique hash value of a reference is inserted into a thesis being written, the block information generation unit 141 may generate block information that further includes a unique hash value of the reference for a block formed from the character string or image.

As described above, when a character string or image inserted into a thesis has a reference, that is, a unique hash value of the original text, the block information generation unit 141 may add the unique hash value of the reference included in the string or image into the block information as hash pointer information. Therefore, when the block generated by the character string or image inserted into the thesis is extracted from a reference, block information including both a unique hash value, which is a unique value of the block according to the thesis being written, and hash pointer information indicating a unique hash value corresponding to a portion of the extracted reference.

Furthermore, the blocking unit 140 may match the generated block information to a block having a character string or image extracted from the reference. Therefore, when a block inserted into a thesis includes a character string or image extracted from a reference, the block (extract block) may be matched to block information including a block serial number according to the order of blocks included in the thesis, information on a time at which the block was generated or modified (time stamp information), a unique hash value, and the hash pointer information

On the contrary, the block information generation unit 141 may generate block information that has only a unique hash value in the case of a block formed by a paragraph formed by letters and images directly written by the user. Furthermore, the blocking unit 140 may match the generated block information to a block formed from characters and images directly written by the user. Therefore, a block (genesis block) formed from characters and images directly written by the user may be matched to block information that does not include hash pointer information.

Meanwhile, the memory 150 may store a program for operating the server controller 100, and various data to be input or output may be stored therein. As an example, reference data received from the reference database 30 according to a retrieval request and block information corresponding to each block of the reference data may be stored in the memory 150. Here, the block information may be encrypted and stored.

Additionally, a portion of the reference scanned and recognized by the scanning unit 130, that is, extract data, may be stored in the memory 150. In addition, at least one unique hash value matching the original text corresponding to each paragraph of the extract data, that is, a portion of the reference, may be stored. In this case, the unique hash value of the at least one reference that matches the extract data may be encrypted and stored. Hereinafter, a region on the memory 150 in which extract data and at least one unique hash value matching the extract data are stored will be referred to as an extract data storage unit 151.

In addition, block information matching each block formed for each paragraph constituting the thesis currently being written may be stored in the memory 150. Hereinafter, a region on the memory 150 in which the block information is stored will be referred to as a block information storage unit 152.

Additionally, data (thesis data) of a thesis being written by the user may be stored through the user terminal 20. In this case, the thesis data may include at least one genesis block and at least one extract block inserted into the thesis being written. In addition, the thesis data may be encrypted and stored. Hereinafter, a region on the memory 150 in which the thesis data is stored will be referred to as a thesis data storage unit 153.

Furthermore, the server controller 100 may control an overall operation of the service server 10, and control each element connected thereto. The server controller 100 may generate thesis data according to the user's request transmitted through the user terminal 20, and control the writing unit 120 to receive characters and images input from the user terminal 20 as authoring data, and insert the received authoring data into the thesis being written by the user. Furthermore, according to the user's request, a thesis into which authoring data has been inserted may be stored as the thesis data.

When authoring data is received, the server controller 100 may insert the received authoring data into the thesis. Furthermore, when the inserted authoring data forms a preset block unit, for example, a page, sentence, paragraph or chapter, the blocking unit 140 may be controlled to perform blocking on the authoring data forming the blocking unit. In this case, when the blocking unit is a paragraph, the blocking unit 140 may be controlled to block the inserted authoring data into one block in a case where the authoring data inserted into the thesis forms one paragraph, generate block information including a unique hash value, which is block identification information, and match the block information to the block.

Additionally, the server controller 100 may provide a retrieval for a reference in response to a request from the user terminal 20. Furthermore, when a reference is retrieved in response to a request, the user terminal 20 may be allowed to access the retrieved reference so that the user may view the retrieved reference.

Then, for a reference that is allowed to be viewed, an input for marking a portion of the reference may be transmitted from the user terminal 20. Furthermore, when at least a portion of the retrieved reference is selected by the user through a marking input, the server controller 100 controls the scanning unit 130 to scan the selected portion of the reference, and recognize the scanned portion of the reference as a character string and an image. Furthermore, a unique hash value of the reference corresponding to the scanned portion of the reference may be extracted, and the extracted unique hash value and the scanned and recognized portion of the reference may be stored as extract data.

Furthermore, when the user's input who wants to insert the extract data into the thesis is applied, the server controller 100 may insert a piece including the scanned and recognized portion of the reference, that is, a character string or image, into the thesis being written. Furthermore, the blocking unit 140 may be controlled to block the inserted piece, generate block information including both hash pointer information corresponding to a unique hash value of the reference and a unique hash value as a block included in the thesis data, and match the blocked piece to the generated block information.

Therefore, in the thesis data being written, a portion including extract data may include extract blocks that have both a unique hash value, which is the identification information of the block, and hash pointer information indicating the unique hash value of the extracted original text, that is, the reference. On the contrary, the other portion of the thesis data that does not include extract data may include genesis blocks that only have a unique hash value, which is the identification information of the block.

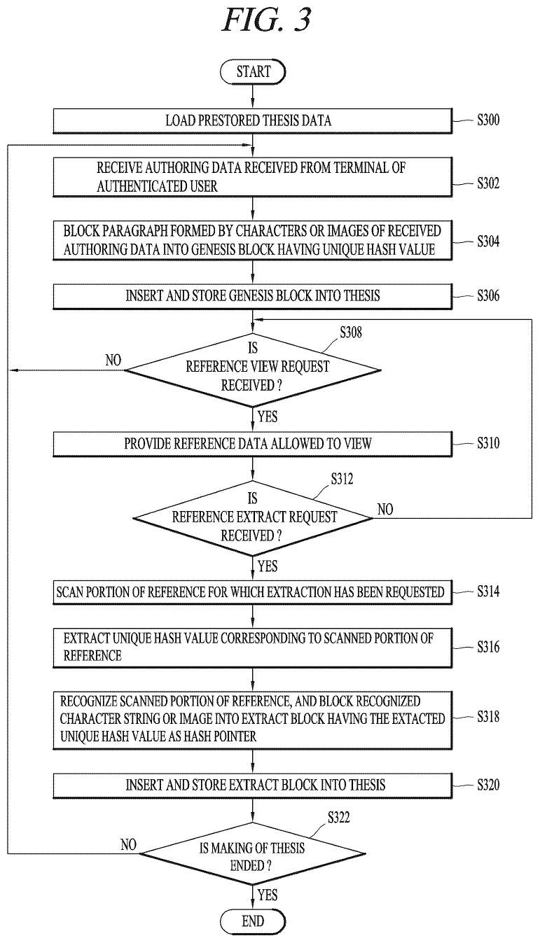

FIG. 3 is a flowchart showing an operation process of writing a thesis in the service server 10 of a thesis making system according to an embodiment of the present disclosure.

Referring to FIG. 3, the service server 10 of the thesis making system according to an embodiment of the present disclosure may load data of the thesis being written by the user, that is, the thesis data, from the memory 150 according to the preregistered user's request (S300). Furthermore, when authoring data, that is, characters and images, for making the thesis are received from the authenticated user's terminal, the input authoring data may be received (S302). Furthermore, when the characters or images of the received authoring data form a preset unit, for example, a paragraph, the character strings or images forming the paragraph may be blocked into a block (genesis block) with a unique value (unique hash value) (S304). Furthermore, the generated genesis block may be inserted into the thesis being written. Furthermore, the service server 10 may store data (thesis data) of the currently written thesis (S306). Therefore, thesis data including the genesis block may be stored.

Furthermore, the service server 10 may detect whether a request for viewing the reference has been received from the user terminal 20 (S308). Here, the reference for which viewing is requested may be a reference for which the user has previously requested a retrieval, and has been retrieved from the reference database 30 upon request and data related thereto (reference data) has been stored.

As a result of the detection in the step S308, when there is no request to view the reference from the user terminal, the service server 10 may proceed again to step S302 to receive authoring data again for making the thesis from the user terminal 20. Furthermore, the service server 10 may perform a process from step S302 to step S306 to insert a genesis block formed according to the received authoring data into the thesis being written. On the contrary, as a result of the detection in step S308, when a request to view a reference is received from the user terminal 20, the service server 10 may provide the data of the reference for which viewing has been requested to the user terminal 20 so as to allow the user to view (S310).

Here, the step S310 may further include a process of receiving, by the service server 10, a retrieval request for a specific reference from the user terminal 20, and retrieving data of the specific reference corresponding to the received search request from the reference database 30. Accordingly, even when the reference that the user has requested to view is a reference that has not previously been requested to be retrieved, the data of the reference that the user has requested to view may be provided in the step S310.

Furthermore, the service server 10 may detect whether there is a request from the user to extract a portion of the provided reference (S312). Furthermore, when there is no request for extraction in step S312, the service server 10 may perform step S308 again to detect whether viewing of the reference has been requested from the user terminal 20. Here, the extract request may be performed through the user's input marking a portion of the provided reference.

Meanwhile, as a result of the detection in the step S312, when there is a request to extract a portion of the reference from the user terminal 20, the service server 10 may scan and recognize the portion of the reference for which the extraction has been requested (S314). Furthermore, a unique hash value corresponding to the scanned and recognized portion of the reference may be extracted from the reference data (S316).

Then, the service server 10 may recognize the scanned portion of the reference as a character string or image. Furthermore, the recognized character string or image may be blocked into an extract block including the unique hash value extracted in the step S316 as block information (S318). Here, the unique hash value extracted from a portion of the reference may be included as hash pointer information corresponding to the extract block, and may be information differentiated from the unique hash value, which is block unique information.

Meanwhile, in the step S318, when an extract block corresponding to the scanned portion of the reference is generated, the service server 10 may insert the extract block into the thesis currently being written according to the user's request. Furthermore, the service server 10 may store data (thesis data) of the currently written thesis (S320). Accordingly, thesis data including the extract block may be stored. Additionally, a unique hash value (hash pointer) corresponding to the character string and image of the reference inserted as a portion of the thesis may be stored as block information matching the extract block. Therefore, when the user extracts a character string or image from a reference while making a thesis and inserts it into the thesis, the original text of the character string or image inserted into the thesis, that is, the identification information of the reference, may be stored to correspond to the extracted character string or image.

Furthermore, the service server 10 may detect whether the user has requested to end the making of the thesis (S322). Furthermore, when the user selects to end the making of the thesis, a thesis making process shown in FIG. 3 may be ended. However, when the user does not select to end the making of the thesis, the process may proceed again to step S302 to receive the characters and images entered by the user as authoring data for making the thesis. Furthermore, the user may proceed with a process subsequent to step S302.

Meanwhile, in the above description, although it has been described as an example in which a genesis block is generated based on authoring data received from the user terminal 20, and step S308 is carried out to detect whether a retrieval of a reference has been requested after the generated genesis block is inserted into the thesis, there may, of course, be no authoring data received from the user terminal 20. That is, in the step S300, while the thesis data currently being written is loaded according to the user's request, when there is no input of authoring data, the service server 10 may, of course, proceed directly to step S308 to detect whether a request for viewing the reference has been made, and perform the processes following step S310 according to the detection result.

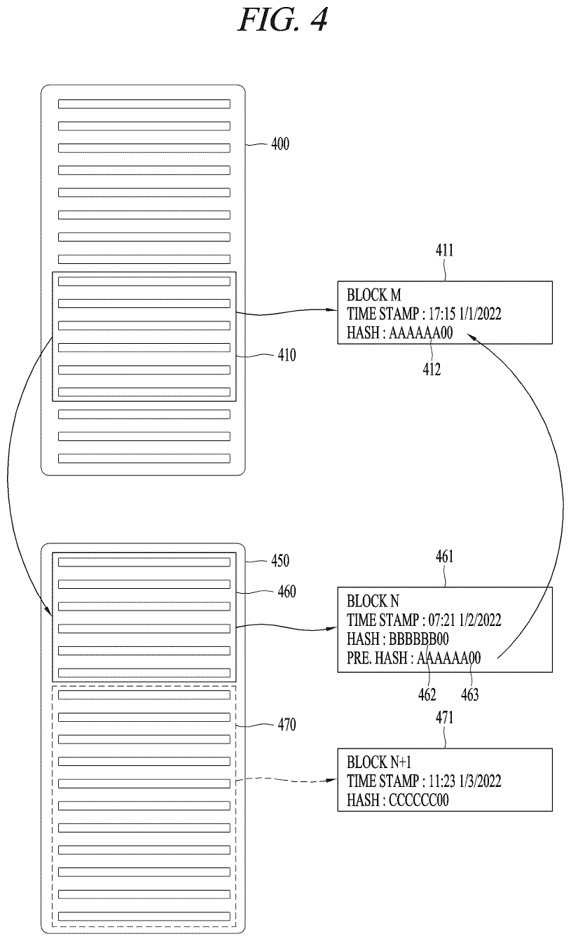

Meanwhile, FIG. 4 is an exemplary diagram showing an example of blocking a partial character string extracted from a reference while making a thesis in the thesis making system according to an embodiment of the present disclosure into an extract block including a unique hash value of the reference.

Referring to FIG. 4, a first document 400 may be a reference requested by a user. In this case, the user may select a portion 410 of the first document 400. Then, the portion 410 of the first document 400 may be marked to be differentiated from the other region and may be extracted from the first document 400 according to the user's request.

In this case, the service server 10 may scan the portion 410 of the first document 400 for which the extraction has been requested. Furthermore, recognition data may be generated by recognizing the scanned portion 410 of the first document 400. Furthermore, when recognition data that has recognized the scanned portion 410 of the first document 400 is generated, the service server 10 may block the recognition data to generate an extract block.

Here, the recognition data may include only at least one character or at least one image. For example, when the scanned portion of the first document 400 includes only at least one character or includes only at least one image, the recognition data may include only at least one character or at least one image. On the contrary, when the scanned portion of the first document 400 includes both at least one character and at least one image, the recognition data may include both the at least one character and at least one image.

Meanwhile, while blocking the recognition data into an extract block, the service server 10 may extract unique information of the first document 400 corresponding to the extract block. As an example, the first document 400 may be a document blocked according to a page, sentence, paragraph, or chapter, as described above. In this case, each block of the first document 400 may include block serial information, time stamp information, and a unique hash value, which is block unique information, as block information.

Therefore, as shown in FIG. 4, when a portion 410 of the first document 400 is extracted, the service server 10 may extract block information 411 from a block of the first document 400 including the portion 410 of the first document 400. Furthermore, a unique hash value 412, which is a unique value of the corresponding block, may be extracted from the extracted block information 411.

Meanwhile, a second document 450 shown in FIG. 4 may be a thesis currently being written by the user. In this case, as shown in FIG. 4, the second document 450 may include an extract block 460 including recognition data obtained by scanning and recognizing the extracted portion 410 of the first document 400, and a genesis block 470 including at least one character and/or image (authoring data) directly entered by the user.

In this case, the extract block 460 and the genesis block 470 may include a block serial number according to the arrangement order of blocks according to the making of the thesis, a time at which each block was inserted into the thesis (time stamp), and block information including block unique information. Here, as shown in the second document 450 of FIG. 4, when the extract block 460 is inserted before the genesis block 470, the block serial number of the genesis block 470 (N+1) may have a lager value than that of the extract block 460 (N).

Meanwhile, as shown in FIG. 4, block information 461 corresponding to the extract block 460 may further include a unique hash value 412 extracted from the block information 411 for a portion of the first document 400 corresponding to the extract block 460. In this case, the unique hash value 412 extracted from the block information of the first document 400 may be differentiated from the unique hash value 462, which is a unique value of the extract block 460.

That is, as shown in the extract block-block information 461 of FIG. 4, the unique value of the excerpt block 460 may be included in the extract block-block information 461 as a unique hash value (HASH) 462, and the unique hash value 412 of the block information 411 extracted from the first document 400, which is the original extract, may be included in the extract block-block information 461 as a hash value of the previous document (Previous HASH, Pre. HASH) 463, that is, hash pointer information.

Meanwhile, unlike the extract block 460, in the case of the genesis block 470 including characters and images according to authoring data entered by the user, the block information 471 of the genesis block 470 may be block information that does not include hash pointer information as shown in FIG. 4.

Meanwhile, while extracting a portion of a reference, the user may modify a portion of the recognition data scanned and recognized from the extracted reference, or add content thereto to insert it into his or her thesis. In this case, the service server 10 may generate the modified and added portion of the extracted reference as a block (genesis block) according to the authoring data entered by the user, and store the generated portion separately from the extract block.

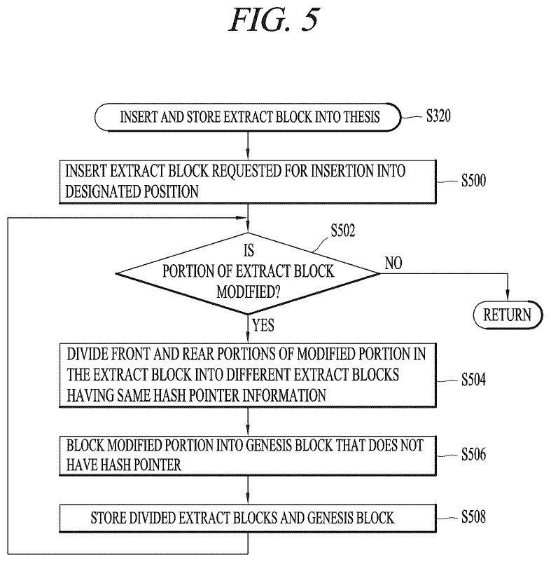

FIG. 5 is a flowchart showing an operation process of dividing, when there is a modification to an extracted portion as described above, the modified portion into a genesis block in the thesis making system according to an embodiment of the present disclosure.

Referring to FIG. 5, when the process of inserting and storing the excerpt block into the thesis is carried out in step S320 of FIG. 3, the service server 10 may first insert the extract block requested for insertion into a designated position on the thesis (S500). Furthermore, the service server 10 may detect whether there is a modification to the inserted extract block (S502).

Here, the modification of the extract block may include changing characters or images or adding characters or images. Accordingly, the service server 10 may detect whether a change has been made to the characters or images constituting the extract block for the inserted extract block in the step S503. Additionally, it may be detected whether at least one additional character or at least one image has been added to the inserted extract block. Furthermore, as a result of the detection in the step S502, when there is no change or addition to characters or images constituting the extract block, it is determined that there is no modification to the extract block, and the process may proceed to step S322 in FIG. 3 to detect whether the end of the making of the thesis has been requested.

On the contrary, as a result of the detection in the step S502, when there is a change or addition to characters or images constituting the extract block, the service server 10 determines that there is a modification to the extract block. Then, the service server 10 may divide a front portion of the modified portion in the extract block, that is, the portion where characters or images are changed or added, and a rear portion of the modified portion into different extract blocks having the same hash pointer information (S504).

Furthermore, the service server 10 may block the modified portion in the extract block into a genesis block that is differentiated from the extract block (S506). Therefore, a portion to which the user has changed or added content, in the extract block, may be blocked as a genesis block corresponding to block information that does not have hash pointer information (S506).

Furthermore, the service server 10 may store thesis data including an extract block divided into a plurality of extract blocks and at least one genesis block, and a genesis block (S508). Then, the process may proceed again to step S502 to detect whether the user has modified a portion of the extract block again. Furthermore, when an additional modification to the extract block occurs, a process from steps S504 to S508 may be performed again. However, when there is no modification, the process may proceed to step S322 of FIG. 3 to detect whether the end of the making of the thesis has been requested.

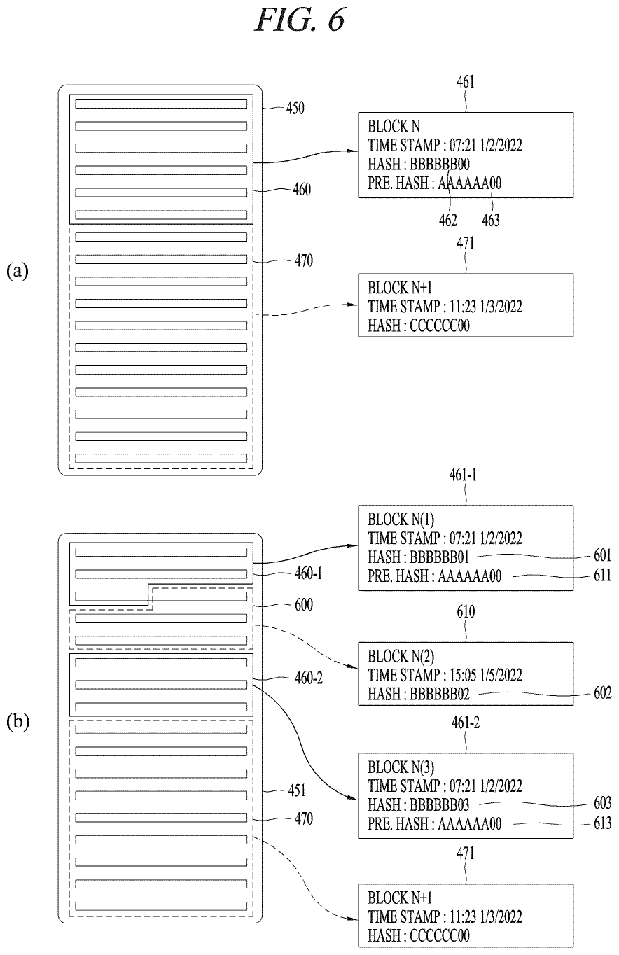

FIG. 6 is an exemplary diagram showing an example in which an extract block is divided into a genesis block including the modified or added portion and an extract block according to the operation process of FIG. 5.

First, referring to (a) of FIG. 6, (a) of FIG. 6 shows an example of a thesis 450 being written including an extract block 460 and a genesis block 470. In this case, the genesis block 470 may not have hash pointer information (Pre. HASH), as shown in the block information 471 of the genesis block 470. On the contrary, as shown in the block information 461 of the extract block 460, the extract block 460 may include not only the unique hash value (HASH) 462, which is block unique information, but also the unique information (unique hash value) of the original extract as hash pointer information (Pre. HASH, 463).

In this way, while the extract block 460 is inserted into the thesis 450 and the block information 461 of the extract block 460 is stored, the service server 10 may detect the user's authoring data added to the extract block 460. That is, when the user enters a character string or image into the extract block 460, as in the thesis 451 as shown in (b) of FIG. 6, the authoring data 600 entered by the user into the extract block 460, that is, the character string or image, may be added thereto.

Then, the service server 10 may block a first portion 460-1 of the extract block 460 corresponding to a front portion of the authoring data 600, and a second portion 460-2 of the extract block 460 corresponding to a rear portion of the authoring data 600 into different extract blocks, respectively, around the user's authoring data 600 added into the extract block 460. In this case, an extract block corresponding to the first portion 460-1 (hereinafter referred to as a first extract block) and an extract block corresponding to the second portion 460-2 (hereinafter referred to as a second extract block) may be blocked into separate blocks having different block serial numbers, time stamp information, and unique hash values, which are block unique information.

In this case, like the block information 461-1 of the first extract block 460-1 and the block information 461-2 of the second extract block 460-2 as shown in (b) of FIG. 6, the unique hash value 601 corresponding to the first extract block 460-1 and the unique hash value 603 corresponding to the second extract block 460-2 may be different from each other. In addition, it may be different from the unique hash value 462 of the existing extract block 460. However, the block information 461-1 corresponding to the first extracted block 460-1 and the block information 461-2 corresponding to the second extracted block 460-2 may have the same hash pointer information 611, 613. That is, the first extract block 460-1 and the second extract block 460-2 may be extract blocks that include the same hash pointer information as block information.

Meanwhile, the user's authoring data 600 added into the extract block 460 may be generated as a genesis block matching block information 610 that does not include hash pointer information. In this case, the block information 610 corresponding to the newly generated genesis block may include unique block information (unique hash value) 602, a block serial number, and time stamp information. In this case, the unique hash value of the block information 610 corresponding to the newly generated genesis block may also have a different value from the unique hash value 462 of the existing extract block 460.

Meanwhile, in the above description, a case where authoring data received from the user is added into an extract block has been described, but even when a portion of the extract block is deleted and the extract block into which authoring data replacing the deleted portion is input is changed, similar to as shown in FIGS. 5 and 6, the extract block may be divided into a plurality of extract blocks and at least one genesis block. In this case, block information corresponding to divided blocks, respectively, may have different unique hash values. On the contrary, the block information of the extract blocks among the divided blocks may include hash pointer information that is the same as the hash pointer information of the extract block prior to division.

Meanwhile, in the above description, a case where authoring data entered from the user is added into the extract block has been described, but the present disclosure may, of course, also be applicable to a case where the extract block consists of one image and the user modifies the image (extract block).

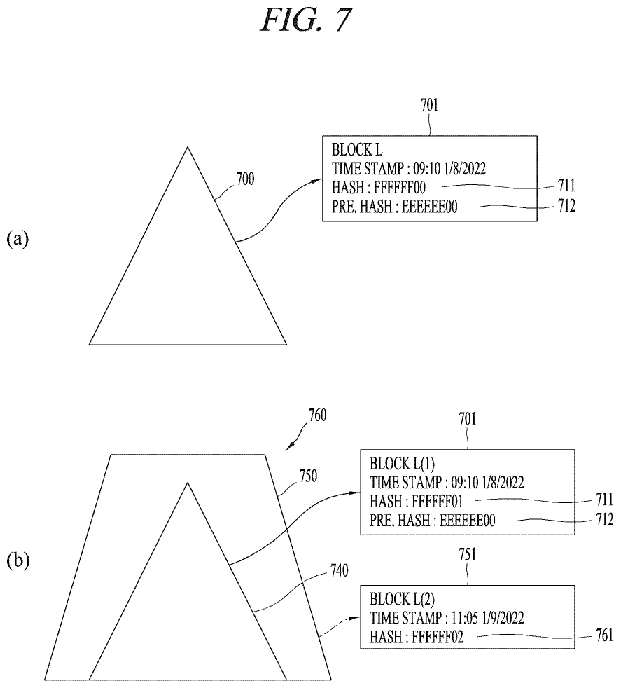

FIG. 7 is an exemplary diagram showing an example in which block information on each of an edited portion and an original image is generated according to the operation process of FIG. 5 when the extracted portion is an image as described above.

First, referring to (a) of FIG. 7, (a) of FIG. 7 assumes that an extract block is generated as one image 700 (hereinafter referred to as an extract image). For example, when an image is selected and extracted from a reference, the extract image 700 may include a unique hash value corresponding to an image of the reference as hash pointer information 712, and may be matched to block information 701 including a unique hash value 711, which is block unique information as an extract block included in the thesis data being written.

In this case, the service server 10 may receive the user's edit request for the extract image 700. Then, the extract image 700 may be edited through various editing functions provided by the editing unit 121. For example, as shown in (b) of FIG. 7, an edited image 760 including an image region 760 added by the user through editing and an image region 740 corresponding to the existing extract image 700 may be generated.

Then, the service server 10 may first generate new block information 751 corresponding to the image region 760 added by the user through editing. In this case, the new block information 751 may be generated as block information of a genesis block including a block serial number, time stamp information, and a unique hash value 761 as a block included in the thesis data being written. That is, it may be block information that does not include hash pointer information. Furthermore, the service server 10 may match the generated genesis block information 751 to the edited image 760.

Furthermore, the service server 10 may further match the existing block information 701 corresponding to the existing extract image 700, that is, the extract block information 701 with the hash pointer information 712 to the edited image 760. Therefore, as shown in (b) of FIG. 7, the edited image 760 generated by editing the existing extract image 700 may be matched to both the genesis block information 751 without the hash pointer information 712 and the extract block information 701 with the hash pointer information 712.

That is, the service server 10 may differentiate an unedited portion from an edited portion of the image by tracking an editing process of the image extracted from the reference, and match the extract block information 701 and the genesis block information 751 to the unedited portion and the edited portion of the image, respectively. Therefore, the edited image 760 including both the edited portion and the unedited portion may be matched to both the genesis block information 751 and the extract block information 701.

Meanwhile, the service server 10 according to an embodiment of the present disclosure may provide a structural model that provides block information for each block inserted into the thesis. For example, the structural model may be generated according to the structure of a table of contents of the thesis, and may include information related to each block in the thesis included in each table of contents.

As an example, the structural model may be a model that provides information on extract blocks among blocks inserted into the thesis. In this case, the structural model may provide information on extract blocks included in each table of contents according to the table of contents structure of the thesis.

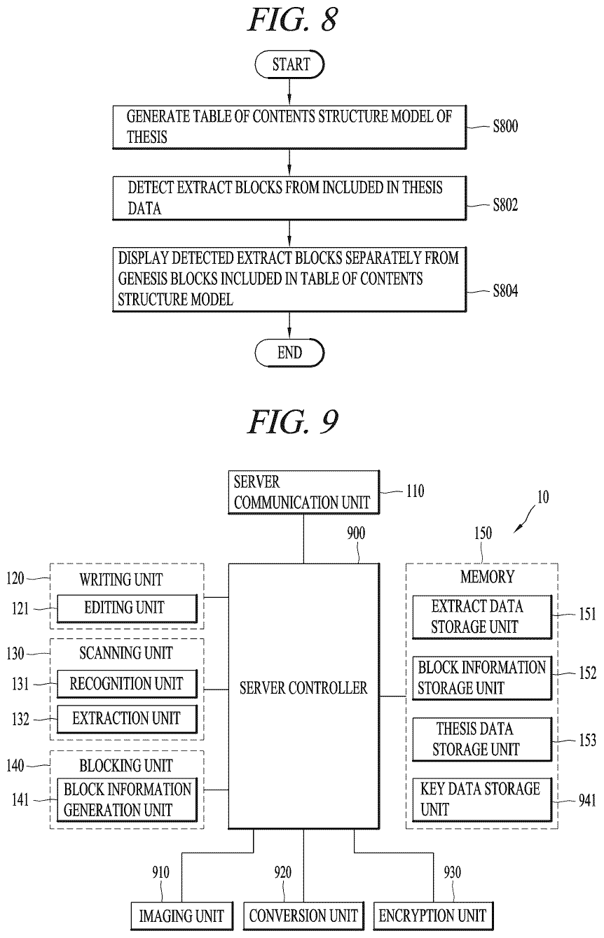

FIG. 8 is a flowchart showing an operation process of generating a table of contents structure model that displays information on block information generated according to an embodiment of the as the present disclosure as described above.

Referring to FIG. 8, the service server 10 according to an embodiment of the present disclosure may first generate a table of contents structure model corresponding to the table of contents structure of the currently written thesis (S800). In this case, the table of contents structure model may have a tree-shaped structure according to the table of contents structure of the thesis, and for each table of contents, block information of blocks included in each table of contents may be matched thereto. That is, each block that constitutes the thesis may be classified into each topic.

When the generation of the table of contents structure model is completed in the step S800, the service server 10 may detect only block information of extract blocks from among the block information included in the thesis data (S802). For example, the service server 10 may detect blocks including hash pointer information from among block information included in thesis data as block information of the extract blocks.

Then, the service server 10 may display the block information of the extract blocks detected in the step S802 from the table of contents structure model separately from the block information of the genesis block (S804). Accordingly, the service server 10 may more easily check the amounts and positions of extract blocks included in the thesis currently being written through the block information displayed through the table of contents structure model.

In the above description, the detection of block information of extract blocks has been described as an example, but, of course, conversely, the detection of block information of genesis blocks may also be carried out.

Meanwhile, contrary to the foregoing description, the service server 10 may, of course, detect only the block information of extract blocks from among the block information included in the thesis data, and also extract hash pointer information from each detected block information. In addition, hash pointer information extracted from each extract block may be displayed at each position on the model for each table of contents structure corresponding to the table of contents including the extract block. In this case, information (hash pointer information) indicating the original extract of the extract block may be displayed in the table of contents including the extract block from among the models for each table of contents structure.

Meanwhile, hash pointer information included in the block information of the extract block may be information indicating the position of the original extract (reference) corresponding to the extract block. Therefore, the service server 10 may provide a link function to a reference corresponding to the hash pointer information for each hash pointer information displayed on the model for each table of contents structure. Furthermore, a reference tracking function according to the hash pointer information may be provided.

Therefore, when the user selects any one hash pointer information displayed on the model for each table of contents structure, the data of the reference corresponding to the hash pointer information may be connected to the user terminal 20 through the link function. Therefore, the user may immediately check a portion of the linked reference through the user terminal 20.

Here, the portion of the reference may also be data extracted from another reference. In this case, block information corresponding to a portion of the linked reference may include unique information (unique hash value) of the other reference as hash pointer information. In this case, the service server 10 may provide another link according to hash pointer information included in the block information of the other reference connected through the link.

Accordingly, when the reference extracted by the user when making a thesis is extracted from another reference, the service server 10 according to an embodiment of the present disclosure may track the reference (original reference) of the original author who first wrote a portion extracted by the thesis author through a continuous link. In addition, the history of the extracted portion from the original reference to the thesis currently being written may also be provided as tracking and tracked history information.

Meanwhile, according to the foregoing description, it has been mentioned that the thesis making system according to an embodiment of the present disclosure may provide a preview function for the thesis being written through a terminal designated in advance by the user. In this case, the service server 10 may encrypt and transmit the thesis being written, and the encrypted thesis may be decrypted using the identification information of the pre-designated terminal or the user's authentication information.

Here, the user terminal, which is a terminal used by the user to make the thesis, may be a designated terminal that allows preview of the thesis being written. Alternatively, even when it is not the terminal used to make the thesis, it may be a terminal designated in advance by the user to allow preview of the thesis.

FIG. 9 is a block diagram for explaining the service server of the thesis making system according to an embodiment of the present disclosure that provides an encrypted preview function for a thesis being written.

Referring to FIG. 9, in order to further provide the encrypted preview function, a service server 11 according to an embodiment of the present disclosure may further include a conversion unit 920 and an encryption unit 930 connected to the server controller 900. In addition, in order to provide the encrypted preview function, it may further include an imaging unit 910 that scans the thesis currently being written and generates image data corresponding to the thesis. It may also include a memory 940 that further includes a key data storage unit 941 in which keys related to encryption are stored.

First, the imaging unit 910 may generate image data corresponding to the thesis being written. To this end, the imaging unit 910 may scan the thesis being written. For example, the imaging unit 910 may scan each page of the thesis being written to generate image data corresponding to each page.

Furthermore, under the control of the server controller 900, the conversion unit 920 may encode each of the image data generated by the imaging unit 910 using a preset encoding method to convert the encoded image data into a character string. As an example, the conversion unit 920 may encode image data according to a base64 algorithm. In this case, binary data corresponding to image data may be converted into different characters for every six bits. Therefore, an image corresponding to a page of the written thesis may be converted into a single long character string (character string data).

Furthermore, the encryption unit 930 may encrypt data encoded as a character string in the conversion unit 920, that is, character string data, using a preset encryption method. As an example, the encryption unit 930 may encrypt the character string data according to an Advanced Encryption Standard (AES) algorithm declared in CryptoJS. In this case, the encryption unit 930 may perform compression on the character string data.

Meanwhile, the encryption unit 930 may encrypt the character string data through a different encryption key for each user. Here, the encryption key may include identification information of a viewer terminal capable of previewing the thesis being written.

As an example, the encryption key may include identification information (ID) of the viewer terminal registered with the service server 11 when the user designates the viewer terminal. In this case, the identification information may be unique information of the viewer terminal. In this case, the encryption key may be formed by including identification information (user identification information) issued when the user registers with the service server 10 to generate an account, and identification information of the viewer terminal.

Meanwhile, the time stamp information of the time at which the thesis being written was last modified (last modified time) may be further used as the encryption key. In this case, the encryption key may be generated by a combination of the user identification information, the viewer terminal identification information, and the last modified time information of the thesis, and in this case, an example of the encryption key generated by a combination of the user identification information, the viewer identification information, and the last modified time information of the thesis is as follows.
Combination Example) SYSTEM_ID+“.”+UUID+“.”+USER_TIMESTAMP
0GOEgzwwO9grgKHg4n4lykPd8VB2.9b1deb4d-3b7d-4bad-9bdd-2b0d7b3dcb6d.1656886229347

Here, SYSTEM_ID is the user ID, UUID is the identification information of the viewer terminal, and USER_TIMESTAMP is the last modified time of the thesis.

To this end, when a specific event occurs, the server controller 900 may detect information on the time at which the event occurred. In this case, when the making of the thesis is ended at the user's request, the server controller 900 may detect and store information on the time at which the making of the thesis was completed.

Meanwhile, when the viewer terminal is the user terminal 20 of FIG. 1 that receives authoring data for making a thesis, the time at which the thesis was last modified may be information automatically stored in the user terminal 20. Accordingly, when the viewer terminal and the terminal used by the user to make the thesis are the same, the server controller 900 may not transmit information on the last modified time of the thesis to the user terminal 20. However, when a terminal separate from the user terminal 20 is designated as the viewer terminal, that is, when the identification information of the viewer terminal and the identification information of the user terminal 20 authenticated for the making of the thesis are different, the server controller 900 may transmit information on the time at which the making of the thesis was ended to the viewer terminal. That is, information on the time at which the making of the thesis was ended may be shared between the service server 11 and the viewer terminal.

Meanwhile, in order to provide an encrypted preview of the thesis being written, the memory 940 of the service server 11 may include a key data storage unit 941 in which keys related to encryption are stored. Identification information of the registered user, identification information of the viewer terminal registered by the user, and information on the last modified time of the thesis may be stored in the key data storage unit 941.

Meanwhile, the service server 11 may control the imaging unit 910 to scan the thesis currently being written page by page to generate at least one image data. Furthermore, the conversion unit 920 may be controlled to encode each scanned image data into character string data corresponding to each image data, and the encryption unit 930 may be controlled to encrypt each encoded character string data.

In this case, the server controller 900 may control the encryption unit 930 to use at least one combination of the identification information of the thesis author (user), the identification information of the viewer terminal set in advance by the user, and the last modified time information of the thesis as an encryption key. Here, when the last modified time information of the thesis is used as an encryption key, the server controller 900 may provide the last modified time information of the thesis to the viewer terminal.

When there is a plurality of scanned image data, the server controller 900 may repeat the above process for each image data. Therefore, a plurality of encrypted data for each page of the thesis currently being written may be transmitted to the viewer terminal.

Meanwhile, the server controller 900 may insert at least one of the identification information of the user, the identification information of the viewer terminal, and the last modified time information of the thesis as a drawing key at a preset position in an arbitrarily encoded character string. In this case, the encryption unit 930 may encrypt the character string data into which the drawing key is further inserted, and thus the character string data including the drawing key may be encrypted and transmitted to the viewer terminal.

Here, the position within the character string data where the drawing key is inserted may be a predetermined position through an agreement between the service server 11 and the user. In addition, the identification information of the user, the identification information of the viewer terminal, and the last modified time information of the thesis may all be character strings consisting of the same number of characters.

Additionally, the server controller 900 may insert a different drawing key for each encoded character string data. That is, for each character string data corresponding to each page of the thesis being written, the drawing key inserted into the specified position may be different.

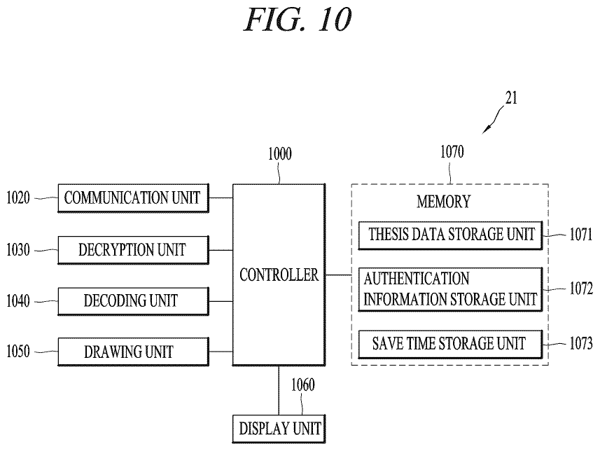

FIG. 10 is a block diagram for explaining a configuration of a viewer terminal in the thesis making system that provides an encrypted preview function of the thesis.

According to an embodiment of the present disclosure, a viewer that provides a preview function of an encrypted thesis, that is, a viewer terminal 21, may include a controller 1000, and a communication unit 1020, a decryption unit 1030, a decoding unit 1040, a drawing unit 1050, a display unit 1060, and a memory 1070, which are connected to the controller 1000 and controlled by the controller 1000. The elements shown in FIG. 10 are not essential for implementing the viewer terminal 21, and thus the viewer terminal 21 described herein may have more or fewer element than those listed above.

Meanwhile, when the viewer terminal 21 is the same device as the user terminal 20, the viewer terminal 21 may further include an input unit (not shown) through which authoring data can be input.

First, the communication unit 1020 may include one or more modules that enable wireless communication between the viewer terminal 21 and an external server such as the service server 11. In addition, the communication unit 1020 may include one or more modules for connecting the viewer terminal 21 to one or more networks.

The communication unit 1020, which is a module that allows the viewer terminal 21 to access the wireless Internet, may be configured to transmit and receive a wireless signal in a communication network based on wireless Internet technologies. Examples of such wireless Internet access may include Wireless LAN (WLAN), Wireless Fidelity (Wi-Fi), Digital Living Network Alliance (DLNA), Wireless Broadband (WiBro), Worldwide Interoperability for Microwave Access (WiMAX), High Speed Downlink Packet Access (HSDPA), High Speed Uplink Packet Access (HSUPA), Long Term Evolution (LTE), LTE-advanced (LTE-A), and the like. The communication unit 1020 may be configured to transmit and receive data from an external server according to at least one wireless Internet technology, including Internet technologies not listed above.

Furthermore, the decryption unit 1030 may decrypt the encrypted thesis preview data received from the service server 11 through the communication unit 1020 using a preset key. Here, the encrypted thesis preview data may be, in the service server 11, data obtained by imaging the thesis written by the user for each page, encoding the imaged data (image data) into character string data, and encrypting the encoded character string data with a preset encryption key. In this case, the encryption key may be a character string generated from at least one combination of the identification information of the user, the identification information of the viewer terminal 21, and the last modified time information of the thesis.

Meanwhile, in order for the decryption unit 1030 to decrypt the encrypted thesis preview data, the encryption key may be used as a decryption key. Therefore, as described above, the decryption key may be generated as at least one combination of the identification information of the user, the identification information of the viewer terminal 21 itself, and the last modified time information of the thesis.

However, the identification information of the user and the identification information of the viewer terminal 21 may be information previously stored in the viewer terminal 21. In addition, when the viewer terminal 21 is the user terminal 20 used to make a thesis, information on the last modified time of the thesis may also be previously stored information. Accordingly, the service server 11 may not transmit information on the last modified time of the thesis to the viewer terminal 21.

However, when the viewer terminal 21 is a separate device from the user terminal 20, the service server 10 may transmit information on the last modified time of the thesis to the viewer terminal 21.

To this end, when the thesis being written is stored from the user terminal 20, the service server 11 may update the time at which the storing was made with information on the last modified time of the thesis. The information on the last modified time of the thesis may be updated whenever the user stores the thesis data being written while making the thesis. That is, the last modified time of the thesis may be the last save time of the thesis being written.

Meanwhile, since the request for making the thesis is requested to the service server 11 through the user terminal 20 used by the user to make the thesis, the user terminal 20 and the service server 11 may share information on the last modified time of the thesis. Furthermore, the service server 11 may transmit information on the updated last modified time of the thesis to the designated viewer terminal 21 every time the last modified time of the thesis is updated. Therefore, when the user terminal 20 and the viewer terminal 21 are separate devices, information on the last modified time of the thesis may be shared with the viewer terminal 21 through the service server 11.

Meanwhile, the decryption unit 1030 may combine the information on the last modified time of the thesis, the identification information of the user previously stored in the viewer terminal 21, and the identification information of the viewer terminal 21 provided from the service server 11 to generate the decryption key.

Therefore, when the user terminal 20 and the viewer terminal 21 are the same device, the preview data of the encrypted thesis may be decrypted without receiving a decryption key from the service server 11. In addition, even when the user terminal 20 and the viewer terminal 21 are not the same device, the service server 11 transmits only the information on the last modified time of the thesis, that is, a portion of the decryption key, to the viewer terminal 21, thereby preventing the entire decryption key from being leaked even if the information on the last modified time of the thesis is leaked. Therefore, the security of thesis preview data may be further improved.

Meanwhile, the service server 11 encodes image data corresponding to the user's thesis preview data into a character string, and encrypts and transmits the encoded data. Therefore, the data decrypted by the decryption unit 1030 may be data encoded with the character string. Furthermore, the viewer terminal 21 may be provided with a decoding unit 1040 that decodes data encoded with the character string into binary data corresponding to image data.

As an example, the decoding unit 1040 may decode base64 encoded character string data into binary data. In this case, the decoding unit 1040 may convert each character included in the character string data into 6 bits corresponding to each character. Therefore, the character string data may be converted into binary data, and the binary data may be image data corresponding to book data for each section purchased by the user.

Then, the viewer terminal 21 may display the image data on the display unit 1060. However, when image data is displayed on the display unit 1060 in the form of a file, unauthorized copying of the image data itself may occur. Accordingly, the viewer terminal 21 according to an embodiment of the present disclosure may display an image corresponding to the image data in a drawing form in one region of the display unit 1060.

The drawing unit 1050 may draw an image corresponding to the binary data in a region of the display unit 1060. That is, rather than outputting an image file by the drawing unit 1050, an image corresponding to the binary data may be displayed in a form in which the image corresponding to the binary data is redrawn in one region of the display unit 1060. This drawing unit 1050 may be implemented using CANVAS API or the like.

Furthermore, the display unit 1060 may display (output) various information processed in the viewer terminal 21. For example, the display unit 1060 may display execution screen information of an application program driven in the viewer terminal 21 or user interface (UI) and graphic user interface (GUI) information in response to the execution screen information.

Meanwhile, the memory 1070 stores data and instructions that support various functions of the viewer terminal 21. The memory 1070 may store a plurality of application programs (or applications) running on the viewer terminal 21, data or instructions for the operation of the service server 10.

The memory 1070 may store algorithms, instructions, and data for performing encoding and encryption in the decryption unit 1030 and the decoding unit 1040, respectively. As an example, the server memory 1070 may store instructions and data for decoding character string data encoded according to a base64 encoding method into binary data, and instructions and data for performing decryption according to an encryption algorithm declared in CryptoJS.

Meanwhile, the memory 1070 may store encrypted thesis preview data transmitted from the service server 10. Hereinafter, a region on the memory 1070 in which the encrypted thesis preview data is stored will be referred to as a thesis data storage unit 1071.

Additionally, the memory 1070 may store the identification information of the user whose account is registered in the service server 11 and the identification information of the viewer terminal 21. In this case, the identification information of the user and the identification information of viewer terminal 21 may be used as a decryption key to decrypt the encrypted data. In addition, the identification information of the user and the identification information of the viewer terminal 21 may be used as a drawing key. Hereinafter, a region on the memory 1070 in which the identification information of the user and the identification information of the viewer terminal 21 are stored will be referred to as an authentication information storage unit 1072.

Meanwhile, when the viewer terminal 21 is the user terminal 20 that transmits authoring data for making a thesis to the service server 11, each time the thesis being written is saved, the time at which the thesis is saved may be stored in the service server 11 and the viewer terminal 21 as the last modified time of the thesis. Therefore, each time the thesis being written is saved, the thesis last modified time stored in the service server 11 and the viewer terminal 21 may be updated. In this case, information on the last modified time of the thesis may be stored in the memory 1070. Hereinafter, a region on the memory 1070 in which information on the last modified time of the thesis is saved will be referred to as a save time storage unit 1073.

However, the viewer terminal 21 may be a terminal arbitrarily designated by the user, separately from the user terminal 20. Then, the service server 11 may compare the identification information of the viewer terminal 21 with the identification information of the user terminal 20 designated by the user to determine whether the viewer terminal 21 and the user terminal 20 are the same. Furthermore, as a result of the determination, when the viewer terminal 21 and the user terminal 20 are not the same, information on the updated thesis last modified time may be transmitted to the viewer terminal 21 each time the thesis last modified time is updated. Then, the viewer terminal 21 can store information on the last modified time of the thesis received from the service server 11 in the save time storage unit 1073.

Furthermore, the controller 1000 may control each element connected thereto, and may control an overall operation of the viewer terminal 21.

First, the controller 1000 may store encrypted thesis preview data transmitted from the service server 10. Furthermore, the decryption unit 1030 may be controlled to decrypt the stored encrypted thesis preview data. Furthermore, the decoding unit 1040 may be controlled to decode the decrypted book data into binary data corresponding to image data.

Furthermore, the controller 1000 may control the display unit 1060 to set a region on the display unit 1060 on which the encrypted thesis preview data will be displayed. Furthermore, the drawing unit 1050 may be controlled to draw an image corresponding to the binary data in the set region on the display unit 1060. Therefore, an image corresponding to the encrypted thesis preview data may be drawn in a region of the display unit 250.

Meanwhile, according to the foregoing description, it has been described that the service server 11 may insert, after encoding the binary data of the image corresponding to each page of the paper preview data into character string data, at least one of the identification information of the user, the identification information of the viewer terminal 21, and the thesis last modification time information as a drawing key into a designated position of the encoded data. Therefore, the encrypted thesis preview data provided by the service server 11 may be data obtained by encrypting the character string data into which the drawing key is inserted.

In this case, when the viewer terminal 21 decodes the character string into which the drawing key is inserted into binary data, binary data that does not correspond to the image is inserted, thereby resulting in a shift of the binary data. Therefore, a correct image is not drawn in the drawing unit 1050.

Accordingly, when the decryption of the thesis preview data encrypted in the decryption unit 1030 is completed, the controller 1000 may extract decrypted data, that is, a designated number of characters from a pre-designated position of the character string data into which the drawing key is inserted, that is, a drawing key insertion position agreed upon with the service server 11 (e.g., at the beginning or after a preset number of characters). In this case, the designated number of characters may be characters constituting the drawing key. Furthermore, the drawing key is any one of the identification information of the user, the identification information of the viewer terminal 21, and the information on the last modified time of the thesis, and the designated number of characters may be a number of characters constituting the identification information of the user, the identification information of the viewer terminal 21, and information on the last modified time of the thesis.

Furthermore, the controller 1000 may compare the extracted characters with any one of the identification information of the user, the identification information of the viewer terminal 21, and information on the last modified time of the thesis to determine whether they match. Furthermore, according to a result of the determination, matching characters may be removed from the decrypted character string data. Therefore, the character string data may be restored to data obtained by encoding the image data corresponding to each page of the thesis into a character string. Then, the controller 1000 may control the drawing unit 1050 to decode the restored character string data and draw an image based on the decoded binary data.

In this way, the controller 1000 may remove characters corresponding to a preset number of drawing keys according to a preset drawing key insertion position from the decrypted character string data. Therefore, when forged thesis data in which a drawing key is not inserted is decrypted into character string data, characters corresponding to the preset number of the drawing keys according to the preset drawing key insertion position may be removed from the character string data. Therefore, a shift occurs due to the removal of characters, and an image corresponding to the binary data in which the shift has occurred is drawn in the drawing unit 1050, so the image may not be drawn or the image may not be drawn correctly. Therefore, forged thesis data may be prevented from being displayed on the viewer terminal 21.

Alternatively, as a result of determining whether the drawing key matches, when the designated number of characters (number of drawing keys) detected from the position of the drawing key do not match any of the identification information of the user, the identification information of the viewer terminal 21, and the information on the last modified time of the thesis, the controller 1000 may not remove the drawing key. Therefore, binary data that does not correspond to the image may be inserted, and an image corresponding to the binary data shifted by a length of characters corresponding to the drawing key may be drawn in the drawing unit 1050, so the image may not be drawn or the image is not drawn correctly.

Hereinafter, embodiments related to a control method that can be implemented in the service server 11 and the viewer terminal 21 configured as described above will be described with reference to the accompanying drawings. It is obvious to those skilled in the art that the present disclosure can be embodied in other specific forms without departing from the concept and essential characteristics thereof.

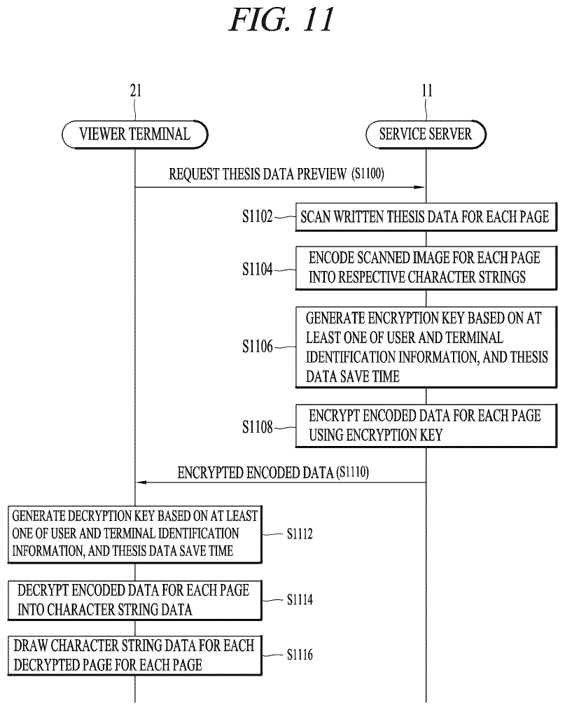

First, FIG. 11 is a flowchart showing an operation process between a service server and a user terminal that provide an encrypted preview service of the thesis in the thesis making system according to the embodiment of the present disclosure. In the following description, it is assumed that the service server 11 shares information on the thesis last modified time with the viewer terminal 21 in advance, so that the service server 11 and the viewer terminal 21 have the same information on the thesis last modified time.

Referring to FIG. 11, the viewer terminal 21 according to an embodiment of the present disclosure may request a preview service for the thesis being written from the service server 11 according to the user's request (S1100).

Then, the service server 11 may scan each page of the thesis for which a preview is requested according to the request of the viewer terminal 21 to generate image data corresponding to each page of the requested thesis (S1102).

Furthermore, the service server 11 may encode image data for each generated page into respective character string data (S1104). In this case, the service server 11 may encode each image data into character string data using a preset encoding algorithm, for example, a base64 encoding algorithm.

When the character string data encoding for each of the image data is completed in the step S1104, the service server 11 may generate an encryption key based on at least one of identification information of the author of the requested thesis, that is, the user, identification information of the viewer terminal 21, and information on the last modified time of the thesis (S1106). Furthermore, character string data corresponding to each image data may be encrypted using the generated encryption key (S1108).

When the encryption in the step S1108 is completed, the service server 11 may transmit the encrypted character string data as encrypted thesis preview data to the viewer terminal 21 (S1110). Then, the viewer terminal 21 may store the encrypted thesis preview data.

Then, the viewer terminal 21 may read the identification information of the user and the identification information of the viewer terminal 21 from the authentication information storage unit 1072 of the memory 1070. Additionally, information on the last modified time of the thesis corresponding to the encrypted thesis preview data may be read from the save time storage unit 1073. Furthermore, a decryption key may be generated by combining the read identification information of the user, the identification information of the viewer terminal 21, and the information on the last modified time of the thesis (S1112).

Furthermore, the viewer terminal 21 may decrypt the encrypted thesis preview data based on the generated decryption key (S1114). In this case, the decrypted book data for each section may be character string data encoded according to a preset encoding algorithm (e.g., base64).

Furthermore, the viewer terminal 21 may draw an image corresponding to the data decrypted in the step S1114, that is, the character string data, in a preset region on the display unit 1060 for each page (S1116). To this end, the viewer terminal 21 may decode data encoded as a character string back into binary data, and display an image corresponding to the decoded binary data in a manner of drawing on the display unit 250 using a preset drawing method (e.g. CANVAS API).

Meanwhile, according to the foregoing description, in addition to the encryption and decryption process, the service server 11 according to the embodiment of the present disclosure may insert at least one of the identification information of the user, the identification information of the viewer terminal 21, and information on the last modified time of the thesis as a drawing key to restrict an image from being drawing when it is not the designated viewer terminal 21 or on forged thesis preview data.

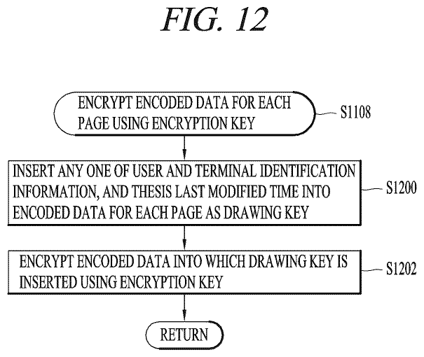

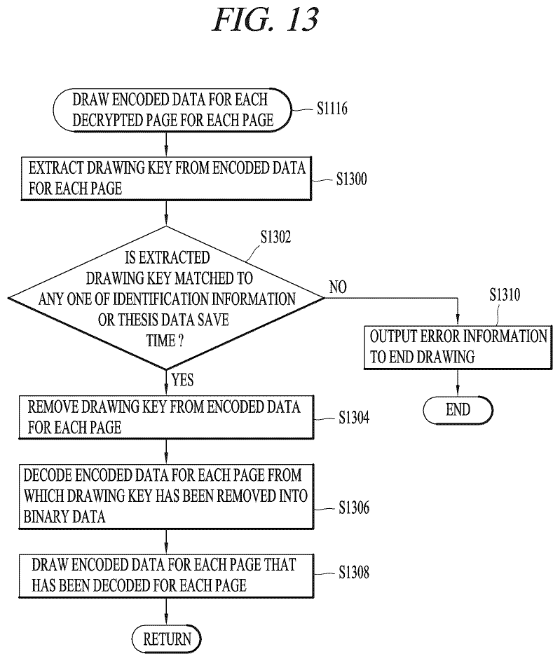

FIGS. 12 and 13 are flowcharts for explaining an operation process of the service server 11 and an operation process of the viewer terminal 21.

FIG. 12 is a flowchart showing an operation process of encrypting, by the service server 11 that provides an encrypted thesis preview service, encoded data in which a drawing key is inserted according to the above embodiment of the present disclosure.

Referring to FIG. 12, when the process of encrypting the encoded data begins in the step S1108 of FIG. 11, the service server 11 may first set any one of the user identification information, the identification information of the viewer terminal 21, and the information on the last modified time of the thesis as a drawing key. Furthermore, the set drawing key may be inserted into character string data in which binary data (image data corresponding to each page of the thesis) is encoded (S1200).

Here, the service server 11 may insert the drawing key into a predetermined position. The following [Example] shows an example in which information on the last modified time of the thesis, which is generated as 14 digits, is inserted as a drawing key at the 5th character position of the character string data.

### Example of Drawing Key Being Inserted

aaaaKKbtmsTTasdf1243omksdf09 . . . : Encoded character string data
20221010101930: Thesis last modified time (Oct. 10, 2022, 10:19:30 pm)
aaaaK20221010101930KbtmsTTasdf1243omksdf09 . . . : Thesis last modified time is inserted into a designated position (after the 5th character) of the drawing key.

Meanwhile, the drawing key may be inserted into the beginning of the encoded character string data or after a predetermined number of characters from the beginning thereof. More preferably, the drawing key may be inserted into a front portion of the character string data. This is because the closer the drawing key is inserted into the first character thereof, the more character string data may be shifted.

Furthermore, the service server 11 may encrypt the character string data into which the drawing key is inserted using the encryption key generated in the step S1106 (S1202). Then, the process may proceed to the step S1110 of FIG. 10 to transmit the encrypted character string data to the viewer terminal 21 as encrypted data of the thesis for which preview has been requested. Therefore, data encrypted with the character string data into which the drawing key is inserted may be transmitted to the viewer terminal 21.

FIG. 13 is a flowchart showing an operation process of decoding, by the viewer terminal 21 according to an embodiment of the present disclosure, encoded data in which a drawing key is inserted, received from the service server 11 that provides an encrypted thesis preview service according to an embodiment of the present disclosure.

Referring to FIG. 13, when the step S1116 of FIG. 11 of drawing an image corresponding to the decrypted encoded data on the display unit 1060 begins, the viewer terminal 21 may first extract the drawing key from the decrypted encoded data (S1300).

In this case, the viewer terminal 21 may extract characters as many as a preset number of digits from a position prearranged with the service server 11 (e.g., the 5th character position), that is, characters as many as the number of characters constituting user identification information, identification information of the viewer terminal 21, or information on the last modified time of the thesis, from the decrypted encoded data, that is, character string data. In this case, when the drawing key is inserted, a character string corresponding to the inserted drawing key, that is, any one of user identification information, identification information of the viewer terminal 21, and information on the last modified time of the thesis, may be extracted from the character string data.

Then, the viewer terminal 21 may check whether the character string extracted in step the S1300 matches any one of the user identification information, the identification information of the viewer terminal 21, and the information on the last modified time of the thesis (S1302). Furthermore, as a result of the check in the step S1302, when the character string extracted in the step S1300 matches any one of the user identification information, the identification information of the viewer terminal 21, and the information on the last modified time of the thesis, the viewer terminal 21 may delete the drawing key, that is, the character string extracted from the character string data (S1304).

### Example of Drawing Key Being Removed

aaaaK20221010101930KbtmsTTasdf1243omksdf09 . . . : Character string data with a drawing key inserted therein
kkk0111-arena2: User's identification information
dlfk0100fhd023: Viewer device identification information
20221010101930: Thesis last modified time (Oct. 10, 2022, 10:19:30 pm)
aaaaKKbtmsTTasdf1243omksdf09 . . . : Character string data with thesis last modified time information being removed

Therefore, when the character string inserted as a drawing key is removed from the decrypted character string data through the step S1304, it may be restored to the character string data in which binary data corresponding to the image data is encoded. Then, the viewer terminal 21 may perform decoding on the encoded data from which the drawing key has been removed to convert the character string data into binary data corresponding to the image data (S1306). Furthermore, an image according to the decoded binary data may be drawn on the display unit 1060 of the viewer terminal 21 (S1308). Therefore, images corresponding to each page of the thesis for which preview has been requested may be displayed on the display unit 1060 of the viewer terminal 21.

Meanwhile, as a result of the check in the step S1302, when the character string extracted in the step S1300 does not match any of the user identification information, the identification information of the viewer terminal 21, or the information on the last modified time of the thesis, the viewer terminal 21 may output error information indicating that the image cannot be drawn. Furthermore, the drawing may be ended (S1310). This is because, when the inserted drawing key is not removed, a correct image cannot be drawn due to noise data corresponding to the inserted drawing key and data shift caused by the drawing key.

Meanwhile, the error information output in step S1310 may be an error message displayed when drawing is attempted while a drawing key is inserted as the character string extracted in the step S1300 does not match any of the user identification information, the identification information of the viewer terminal 21, or the information on the last modified time of the thesis. That is, as described above, when the drawing key is inserted into the beginning or front portion of the character string data, the drawing key may be inserted into a position corresponding to the header portion of the binary data. In this case, when it is encoded as binary data with a drawing key therein, the drawing unit 1050 of the viewer terminal 21 may have difficulty in recognizing the binary data, and thus may output an error message indicating that drawing is not allowed.

The foregoing present disclosure may be implemented as computer-readable codes on a program-recorded medium. The computer-readable medium may include all types of recording devices each storing data readable by a computer system. Examples of the computer-readable media may include a hard disk drive (HDD), a solid state disk (SSD), a silicon disk drive (SDD), a ROM, a RAM, a CD-ROM, a magnetic tape, a floppy disk, and an optical data storage device, and the like, and also include a device implemented in the form of a carrier wave (for example, transmission via the Internet). The above detailed description is therefore to be construed in all aspects as illustrative and not restrictive. The scope of the present disclosure should be determined by reasonable interpretation of the appended claims and all changes that come within the equivalent scope of the present disclosure are included in the scope of the present disclosure.

1. A service server comprising:
a communication unit communicably connected between a preset terminal that receives authoring data comprising characters and images for making a thesis, and a database comprising references for making the thesis;
a scanning unit that scans a portion of a reference retrieved from the database, recognizes characters and images corresponding to the scanned portion of the reference to generate extract data, and extracts unique information of the reference corresponding to the portion of the reference;
a blocking unit that blocks characters and images inserted into the thesis based on the authoring data or the extract data into blocks according to a preset unit, and generates block information matching respective blocks, and comprising identification information of the matching blocks; and
a controller that performs a retrieval for the reference according to a retrieval request received from the terminal, inserts characters and images according to the authoring data or the extract data to make the thesis, and controls, when a block consisting of characters or images inserted into the thesis is an extract block generated by the extract data, the blocking unit to generate block information further comprising unique information of the reference, and to match the block information further comprising the unique information of the reference to the extract block.

2. The service server of claim 1, wherein the preset unit is any one of a sentence, a paragraph, a page, and a chapter.

3. The service server of claim 1, wherein the controller matches, when the block consisting of characters or images inserted into the thesis is a genesis block that does not comprise the characters and images recognized from the reference, block information that does not comprise the unique information of the reference to the genesis block, and
wherein the thesis consists of at least one of the genesis blocks and at least one of the extract blocks.

4. The service server of claim 1, wherein the unique information of the reference is position information comprising a position corresponding to a portion of the reference, and
wherein the controller provides a link to the retrieved reference through the unique information of the reference.

5. The service server of claim 4, wherein the unique information of the reference further comprises, when a portion of the reference is extracted from another reference, the unique information of the other reference, and
wherein the controller further provides a link to the retrieved reference and a link according to the unique information of the other reference.

6. The service server of claim 5, wherein the controller provides, according to a request from the terminal, history information that tracks a history of extracting a portion of the reference from a document of a first author who first wrote the portion of the reference to its insertion into the thesis.

7. The service server of claim 3, wherein the controller controls, when at least one character or image constituting the extract block is changed or at least one character or image is added into the extract block, the blocking block to divide the extract block into different extract blocks that match block information including unique information of the same reference, around the at least one changed or added character or image, and to block the changed or added character or image into a genesis block matching block information that does not comprise the unique information of the reference.

8. The service server of claim 3, wherein the controller controls the blocking unit to differentiate, when the extract block consists of an image and editing is performed on the image, between an unedited portion and an edited portion of the image through tracking the editing process, and to match the unedited and edited portions of the image to the block information of the extract block that further comprises unique information of the reference, and the block information of the genesis block that does not comprise the unique information of the reference, respectively.

9. The service server of claim 1, wherein the controller encrypts, according to a request from the terminal, the thesis being written with an encryption key based on a combination of terminal identification information of the terminal, user identification information of the terminal user, and last modified time information of the thesis to transmit the encrypted thesis to the terminal.

10. The service server of claim 9, wherein the service server further comprises:
an imaging unit that scans each page of the thesis being written to generate image data corresponding to the each page; and
a conversion unit that encodes the image data into character string data,
wherein the controller inserts, when the image data is encoded into the string data, any one of the user identification information, the terminal identification information, and the last modified time information of the thesis as a drawing key into a preset position of the character string data, and encrypts the character string data into which the drawing key is inserted with the encryption key.

11. The service server of claim 10, wherein the controller arbitrarily selects any one of the user identification information, the terminal identification information, and the last modified time information of the thesis to insert the selected information into the drawing key, and
wherein the user identification information, the terminal identification information, and the last modified time information of the thesis are formed of the same number of characters.

12. A terminal that receives preview data of an encrypted thesis from a service server that provides a function of making the thesis, the terminal comprising:
a display unit;
a communication unit that receives preview data of the encrypted thesis from the service server;
a decryption unit that decrypts the preview data of the encrypted thesis into character string data;
a decoding unit that decodes the character string data into binary data of image data corresponding to the preview data of the thesis;
a drawing unit that draws an image corresponding to the decoded binary data in a preset region on the display unit; and
a controller that generates a decryption key using a combination of user identification information previously stored in the terminal, terminal identification information of the terminal, and last modified time information of the thesis, and controls the decryption unit to decrypt the preview data of the encrypted thesis using the generated decryption key.

13. The terminal of claim 12, wherein the last modified time of the thesis is provided from the service server, and updated each time the author terminal making the thesis makes a request for storing the thesis being written through the service server.

14. The terminal of claim 12, wherein the controller extracts, when the encrypted thesis preview data is decrypted into character string data, a preset number of characters from a preset position among the characters of the decrypted character string data as a drawing key, and removes the extracted characters from the character string data when the extracted drawing key matches a drawing key previously stored in the terminal.

15. The terminal of claim 14, wherein the drawing key is any one of the user identification information, the terminal identification information, and the last modified time of the thesis, and
wherein the user identification information, the terminal identification information, and the last modified time of the thesis are formed of the same number of characters.
